(19) United States
(12) Patent Application Publication
(10) Pub. No.: US 2026/0276030 A1
(43) Pub. Date: Sep. 17, 2026

(54) SAFETY FIXED PLATE HOOK WITH MAGNETIC ATTRACTION FUNCTION

(71) Applicant: Taizhou Runjie Logistics Safety Equipment Science and Technology Co., Ltd., Taizhou (CN)

(72) Inventors: Jing Zhou, Taizhou (CN); Xianwei YANG, Taizhou (CN); Chunzhi LI, Taizhou (CN)

(21) Appl. No.: 19/232,008

(22) Filed: Jun. 9, 2025

(30) Foreign Application Priority Data
Mar. 14, 2025 (CN) 202520450910.3

(51) Int. Cl. F16B 45/00

(52) U.S. Cl. CPC F16B 45/005; F16B 2200/83

(57) ABSTRACT

A safety fixed plate hook with magnetic attraction function comprises a plate hook, one end of the plate hook is provided with a hook plate, and the other end is provided with a webbing installation groove. The plate hook is provided with a magnet installation through hole, and a magnet assembly is arranged at the magnet installation through hole. The combined design of the base, magnet seat, magnet, and cross countersunk screw, ensuring tight connections between all parts of the magnet component. During use, it can adsorb onto objects, making the usage more convenient, efficient, and safe. This design ensures stable installation of the magnet on the plate hook, preventing loosening or detachment even under external forces or vibrations. It significantly enhances the structural stability and reliability of the magnet-equipped plate hook, guaranteeing safety and durability during use.

### 1. TECHNICAL FIELD

The invention relates to the technical field of plate hooks, specifically to a safety fixed plate hook with magnetic attraction function.

### 2. BACKGROUND ART

In current cargo transportation, lifting, and outdoor fixation operations, the safety, convenience, and reliability of related equipment have always been key concerns in the industry.

In the field of cargo transportation, various fixation devices are often required to ensure cargo stability during transportation and prevent displacement or falling. Traditional fixation methods primarily use rope binding or ordinary hook connections, but these methods have many drawbacks. For example, the tightness of rope binding is difficult to precisely control: too loose may cause cargo swaying, while too tight may damage packaging; ordinary hooks tend to loosen or detach during vehicle driving due to bumps and vibrations, creating significant safety hazards.

When existing trucks use hand-pullers to secure cargo, operators often encounter loosening or detachment issues on the opposite side of where they operate the hook, posing major safety risks.

Therefore, there is an urgent need for a device that can solve the above problems, this device should feature structural stability, reliable connection, convenient installation, and broad applicability to meet the diverse requirements of cargo transportation, lifting, and outdoor fixation scenarios. To address the issue where existing trucks using hand-pullers for cargo securing create significant safety hazards when operators encounter loosening or detachment on the opposite side of the hook, the invention provides a safety fixed plate hook with magnetic attraction function. Through its unique structural design, including specific magnet assembly and connection methods with the plate hook, this invention effectively resolves existing technical problems and offers a safer, more efficient, and convenient solution for relevant operational scenarios.

### 3. SUMMARY OF THE INVENTION

The invention addresses the above issues by proposing a safety fixed plate hook with magnetic attraction function.

The specific technical scheme is as follows:
a safety fixed plate hook with magnetic attraction function, comprising a plate hook, one end of the plate hook is provided with a hook plate, and the other end is provided with a webbing installation groove; the plate hook is provided with a magnet installation through hole; the webbing installation groove is provided with a webbing, and the magnet installation through hole is provided with a magnet assembly.

The magnet assembly comprises a base, a magnet seat, a magnet, and a cross countersunk screw; the base is provided with a magnet seat installation slot and a screw installation hole; the magnet seat comprises a magnet installation plate and a fixing plate, the magnet installation plate is provided with a magnet fixing groove and a screw installation through hole; a central point of the magnet is provided with a magnet installation hole. The base of the magnet assembly is located behind the magnet installation through hole of the plate hook; the magnet is inserted into the magnet fixing groove on the magnet installation plate of the magnet seat; the magnet seat is inserted into the magnet installation through hole of the plate hook, and the fixing plate of the magnet seat is positioned within the magnet seat installation slot of the base.

The cross countersunk screw sequentially passes through the magnet installation hole of the magnet, the screw installation through hole of the magnet seat to fix with the screw installation hole of the base.

The magnet installation through hole on the plate hook has the same shape as the magnet assembly, they are in the shape of any one of circular structure, elliptical structure, square structure, or other polygonal structures.

### Advantages of the Invention

the safety fixed plate hook with magnetic attraction function of the invention employs a combined design of the base, magnet seat, magnet, and cross countersunk screw, ensuring tight connections between all parts of the magnet component. During use, it can adsorb onto objects, making the usage more convenient, efficient, and safe. This design ensures stable installation of the magnet on the plate hook, preventing loosening or detachment even under external forces or vibrations. It significantly enhances the structural stability and reliability of the magnet-equipped plate hook, guaranteeing safety and durability during use.

### 4. BRIEF DESCRIPTION OF ACCOMPANYING DRAWINGS

FIG. 1 is an overall structural diagram of the invention.

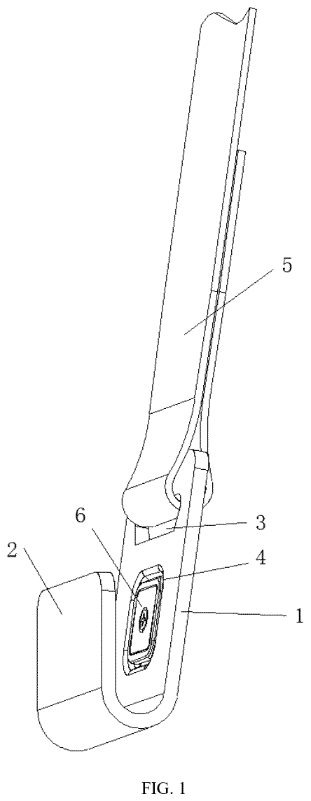

FIG. 2 is an exploded view of the invention.

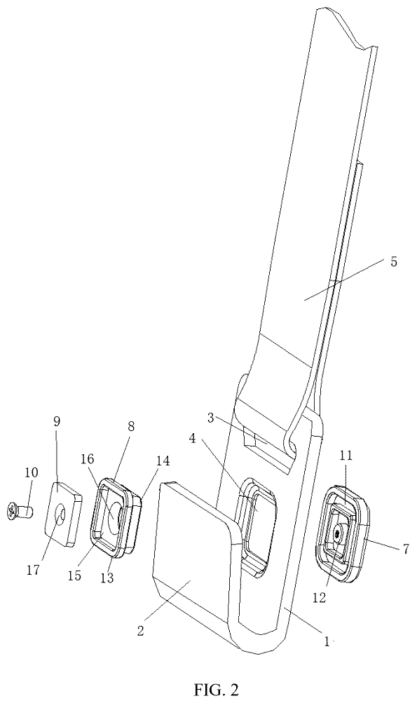

In the drawings: plate hook 1, hook plate 2, webbing installation groove 3, magnet installation through hole 4, webbing 5, magnet component 6, base 7, magnet seat 8, magnet 9, cross countersunk screw 10, magnet seat installation slot 11, screw installation hole 12, magnet mounting plate 13, fixing plate 14, magnet fixing groove 15, screw installation through hole 16, magnet installation hole 17.

### 5. SPECIFIC EMBODIMENT OF THE INVENTION

To clarify the technical scheme of the invention, further descriptions are provided in conjunction with the drawings. Any equivalent substitutions or conventional inferences based on the technical features of the invention fall within the protection scope of the invention.

The technical schemes in the embodiments of the invention will be clearly and completely described in combination with the accompanying drawings in the embodiments of the invention. Obviously, the described embodiments are only some of the embodiments of the invention, but not all of the embodiments. The following description of at least one exemplary embodiment is merely illustrative in nature and is not intended to limit the invention or its application or uses. Based on the embodiments in this invention, all other embodiments obtained by those of ordinary skill in the art without making creative efforts shall fall within the protection scope of this invention.

In the description of the invention, it should be understood that the orientation or positional relationship indicated by the terms “upper,” “middle,” “outside,” “inside,” “lower,” and “surrounding” and so on are based on the orientation or positional relationship shown in the accompanying drawings, only for the convenience of describing the invention and simplifying the description, rather than indicating or implying that the indicated device or element must have a specific orientation, as well as a specific orientation structure and operation, therefore, it should not be construed as a limitation of the invention.

A safety fixed plate hook with magnetic attraction function, comprising a plate hook 1, one end of the plate hook 1 is provided with a hook plate 2, and the other end is provided with a webbing installation groove 3; the plate hook 1 is provided with a magnet installation through hole 4; the webbing installation groove 3 is provided with a webbing 5, and the magnet installation through hole 4 is provided with a magnet assembly 6.

The magnet assembly 6 comprises a base 7, a magnet seat 8, a magnet 9, and a cross countersunk screw 10; the base 7 is provided with a magnet seat installation slot 11 and a screw installation hole 12; the magnet seat 8 comprises a magnet installation plate 13 and a fixing plate 14, the magnet installation plate 13 is provided with a magnet fixing groove 15 and a screw installation through hole 16; a central point of the magnet 9 is provided with a magnet installation hole 17.

The base 7 of the magnet assembly 6 is located behind the magnet installation through hole 4 of the plate hook 1; the magnet 9 is inserted into the magnet fixing groove 15 on the magnet installation plate 13 of the magnet seat 8; the magnet seat 8 is inserted into the magnet installation through hole 4 of the plate hook 1, and the fixing plate 14 of the magnet seat 8 is positioned within the magnet seat installation slot 11 of the base 7.

The cross countersunk screw 10 sequentially passes through the magnet installation hole 17 of the magnet 9, the screw installation through hole 16 of the magnet seat 8 to fix with the screw installation hole 12 of the base 7.

The magnet installation through hole 4 on the plate hook 1 has the same shape as the magnet assembly 6, and the magnet assembly 6 can be fully embedded into the magnet installation through hole 4.

The magnet installation through hole 4 on the plate hook 1 and the magnet assembly 6 are in the shape of any one of circular structure, elliptical structure, square structure, or other polygonal structures.

The safety fixed plate hook with magnetic attraction function of the invention employs a combined design of the base, magnet seat, magnet, and cross countersunk screw, ensuring tight connections between all parts of the magnet component. During use, it can adsorb onto objects, making the usage more convenient, efficient, and safe. This design ensures stable installation of the magnet on the plate hook, preventing loosening or detachment even under external forces or vibrations. It significantly enhances the structural stability and reliability of the magnet-equipped plate hook, guaranteeing safety and durability during use.

The main plate of the plate hook is provided with the magnet installation through hole. The base of the magnet assembly is positioned behind the magnet installation through hole of the main plate. The magnet seat is inserted into the magnet installation through hole of the main plate, the fixing plate of the magnet seat located within the magnet seat installation slot of the base. This design simplifies the installation process of the magnet assembly, requiring no complex tools or operational steps to enable rapid installation. Furthermore, when the magnet assembly is damaged or requires replacement, it can be conveniently disassembled and replaced, reducing maintenance costs and difficulty while enhancing product maintainability and service life.

The magnet installation through hole on the plate hook has the same shape as the magnet assembly, they are in the shape of any one of circular structure, elliptical structure, square structure, or other polygonal structures. This diversified shape design enables the magnet-equipped plate hook to better adapt to different usage scenarios and installation requirements. Users can select appropriately shaped plate hooks according to actual conditions to meet specific installation space and functional requirements, thereby increasing product applicability, flexibility, and expanding its application scope.

The above description merely illustrates preferred embodiments of the invention, but the protection scope of the invention is not limited thereto. Any modifications or substitutions readily conceived by those skilled in the art within the technical scope of the invention should fall within the protection scope of the invention. Therefore, the protection scope of the invention should be determined based on the claims.

1. A safety fixed plate hook with magnetic attraction function, comprising a plate hook (1), one end of the plate hook (1) is provided with a hook plate (2), and the other end is provided with a webbing installation groove (3); the plate hook (1) is provided with a magnet installation through hole (4); the webbing installation groove (3) is provided with a webbing (5), and the magnet installation through hole (4) is provided with a magnet assembly (6).

2. The safety fixed plate hook with magnetic attraction function of claim 1, wherein the magnet assembly (6) comprises a base (7), a magnet seat (8), a magnet (9), and a cross countersunk screw (10); the base (7) is provided with a magnet seat installation slot (11) and a screw installation hole (12); the magnet seat (8) comprises a magnet installation plate (13) and a fixing plate (14), the magnet installation plate (13) is provided with a magnet fixing groove (15) and a screw installation through hole (16); a central point of the magnet (9) is provided with a magnet installation hole (17).

3. The safety fixed plate hook with magnetic attraction function of claim 2, wherein the base (7) of the magnet assembly (6) is located behind the magnet installation through hole (4) of the plate hook (1); the magnet (9) is inserted into the magnet fixing groove (15) on the magnet installation plate (13) of the magnet seat (8); the magnet seat (8) is inserted into the magnet installation through hole (4) of the plate hook (1), and the fixing plate (14) of the magnet seat (8) is positioned within the magnet seat installation slot (11) of the base (7).

4. The safety fixed plate hook with magnetic attraction function of claim 2, wherein the cross countersunk screw (10) sequentially passes through the magnet installation hole (17) of the magnet (9), the screw installation through hole (16) of the magnet seat (8) to fix with the screw installation hole (12) of the base (7).

5. A safety fixed plate hook with magnetic attraction function of claim 1, wherein the magnet installation through hole (4) on the plate hook (1) has the same shape as the magnet assembly (6), and the magnet assembly (6) can be fully embedded into the magnet installation through hole (4).

6. A safety fixed plate hook with magnetic attraction function of claim 1, wherein the magnet installation through hole (4) on the plate hook (1) and the magnet assembly (6) are in the shape of any one of circular structure, elliptical structure, square structure, or other polygonal structures.
